(19) United States
(12) Patent Application Publication
(10) Pub. No.: US 2009/0132292 A1
(43) Pub. Date: May 21, 2009

(54) SYSTEM AND METHOD FOR COMMUNITY BASED INSURANCE

(76) Inventor: Abraham S. Hoppenstein, Boca Raton, FL (US)

Correspondence Address: MORRISON & FOERSTER LLP, 1650 TYSONS BOULEVARD, SUITE 400, MCLEAN, VA, 22102, US

(21) Appl. No.: 12/129,352

(22) Filed: May 29, 2008

Related U.S. Application Data
(60) Provisional application No. 61/124,807, filed on Nov. 19, 2007.

(51) Int. Cl. G06Q 40/00

(52) U.S. Cl. 705/4

(57) ABSTRACT

A system and method for community-based insurance. According to one embodiment, a device may receive one or more attributes of a residential community in which a homeowner owns a residence, determine whether the attributes satisfy criteria to qualify the homeowner for an insurance policy, calculate, if the criteria is satisfied, a premium for the insurance policy, and generate the insurance policy based on the calculated premium.

### CROSS REFERENCE TO RELATED APPLICATION

This application claims the benefit under 35 USC 119(e) of U.S. Provisional Application No. 61/124,807, filed Nov. 19, 2007, the entirety of which is incorporated herein by reference.

### FIELD OF THE DISCLOSURE

The disclosure of the present application relates to insurance, and more particularly, to providing insurance protection to a select group of homeowners.

### BACKGROUND

Historically insurance companies have consistently demonstrated a reluctance to insure potential “high risk” situations. Because they are in the business of optimizing financial returns for shareholders, they share an aversion and non-interest in meeting exceptionally large claims from catastrophic large losses, due to events such as hurricanes for example. In order to enhance profitability, property and casualty insurance companies impose higher insurance premiums while at the same time providing reduced coverage.

In recent times the nation's major personal-lines insurers have resolved to reduce their exposure to catastrophic events. As a result, there has been a calculated shift away from the riskier homeowners' business into the increasingly more profitable auto line.

### SUMMARY

The disclosure of the present application enables the insurance industry to provide innovative comprehensive property and casualty insurance protection to cover a broad field of risks, in a single insurance policy, to a select group of homeowners resident in properly secured communities, such as gated country club communities for example.

### BRIEF DESCRIPTION OF THE DRAWINGS

FIG. 1 illustrates an example of a system architecture.

FIG. 2 illustrates an example of a process for qualifying a homeowner for an insurance policy based on residential community attributes.

FIG. 3 illustrates an example of a process for underwriting an insurance policy for a homeowner based on residential community attributes.

FIG. 4 illustrates an example of a process for generating an insurance policy for a homeowner.

FIGS. 5A, 5B and 5C illustrate an example of an insurance policy request for information form.

FIG. 6 illustrates an example of a computing system.

### DETAILED DESCRIPTION

An insurance product according to embodiments of the present disclosure can provide extensive insurance protection, exclusively for certain wealthy homeowners living in secured residential communities, against many risks to property, commonly referred to as property and casualty insurance. Casualty insurance is generally concerned with the legal liability for losses caused by injury to others or damage to property of others, while property insurance generally provides financial protection against the loss of, or damage to, real and personal property.

The insurance can be provided for widely varied residential property risks such as, for example, damage by fire, lightning, storm, explosion, flood, wind, hurricanes, tornadoes, to homes and automobiles (and their contents), personal umbrella insurance and personal injury protection for example. The insurance can provide indemnification against loss or liability from these events, or circumstances that may occur or be discovered during a specified period. The insurance can also be provided in a single insurance policy issued by mutual or stock companies regulated by national and/or state laws.

This type of insurance coverage is counter-intuitive to accepted property and casualty insurance norms, which are focused on reducing exposure to riskier homeowner coverage perceived by the insurance industry as a factor reducing profitability due to large potential claims. The conventional insurance business model can be described as follows: Profit=earned premium+investment income less: insured loss+underwriting expenses. However, the potential exists to generate reliable earnings growth from the insurance coverage of the present disclosure.

In particular, the select group of homeowners for whom this insurance is provided comprises an advantageous profit-creating insurance group, since they individually and collectively constitute a new business sector. Their wealth enables them to acquire highly priced valuable assets—homes, art, antique furnishings and automobiles for example—and they are receptive to purchasing insurance irrespective of cost as a means to protect and maintain the value of their assets. Further, since these assets are located in a secure residential community in which the homeowner's live, improved underwriting margins can be further realized. In addition, profitability can be enhanced by offering different types of protection for the assets in a single policy.

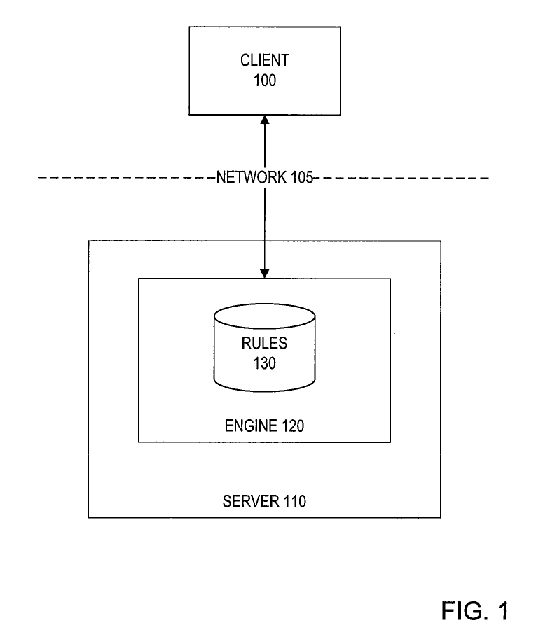

FIG. 1 illustrates an example of a system architecture in an embodiment of the present disclosure. In the illustrated embodiment, client 100 can communicate with server 110 over network 105. Server 110 may include engine 120 and rules 130 stored in a data store. Client 100 may be used to provide certain information about a homeowner to server 110. Server 110 may subsequently utilize engine 120 to determine whether the received homeowner's information satisfies rules 130 for qualifying the homeowner for an insurance policy.

The use of the system may be widely varied. In one embodiment, client 100 may be a computer operated by an insurance agent in the agent's office for keying in homeowner information received in other ways. Such other ways may include a form filled-out by the homeowner and mailed to the agent, or information received by the agent over the telephone from the homeowner for example. In another embodiment, client 100 may be a personal or work computer operated by the homeowner from the homeowner's home or office. In this embodiment, the homeowner may key in the homeowner's information in a web browser hosted by server 110 across the Internet. In other embodiments, the information could be keyed directly into the machine comprising server 110, which could be a standalone machine or connected to network 105.

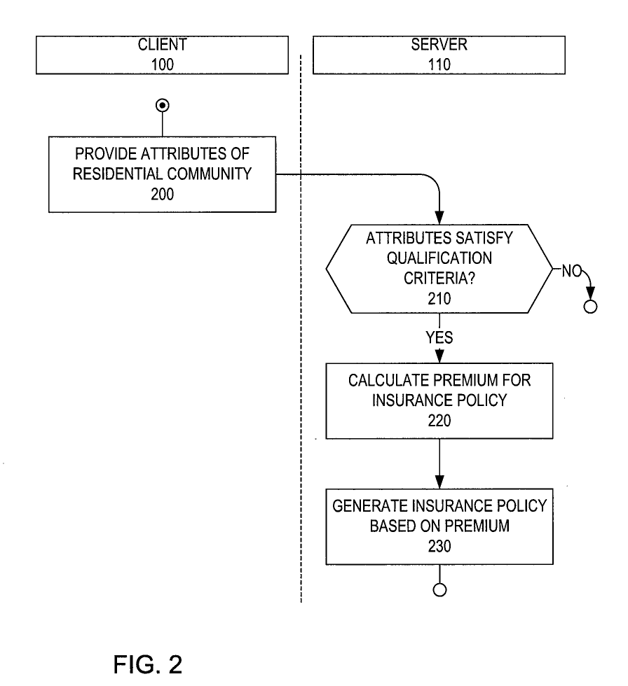

FIG. 2 illustrates an example of a process for qualifying a homeowner for an insurance policy based on attributes of the residential community in which a homeowner lives. In the illustrated embodiment, the residential community attributes are provided (step 200) to server 110. Server 110 utilizes engine 120 to determine (step 210) whether the attributes satisfy criteria to qualify the homeowner for an insurance policy. If the criteria is satisfied, server 110 calculates (step 220) a premium for the insurance policy and generates (step 230) the insurance policy based on the calculated premium.

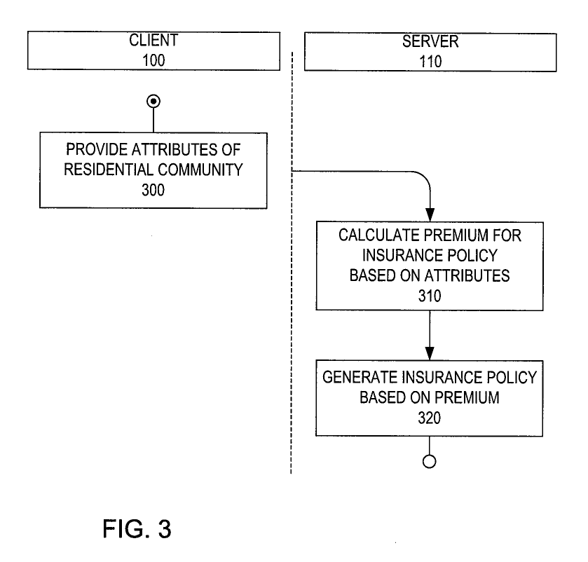

FIG. 3 illustrates an example of a process for underwriting an insurance policy for a homeowner based on residential community attributes. In the illustrated embodiment, the residential community attributes are provided (step 300) to server 100. Server 110 calculates (step 310) a premium for the insurance policy based on the attributes. In this manner, the attributes of the residential community in which the homeowner lives can influence the premium calculated for the policy. Server 110 generates (step 320) the insurance policy based on the calculated premium.

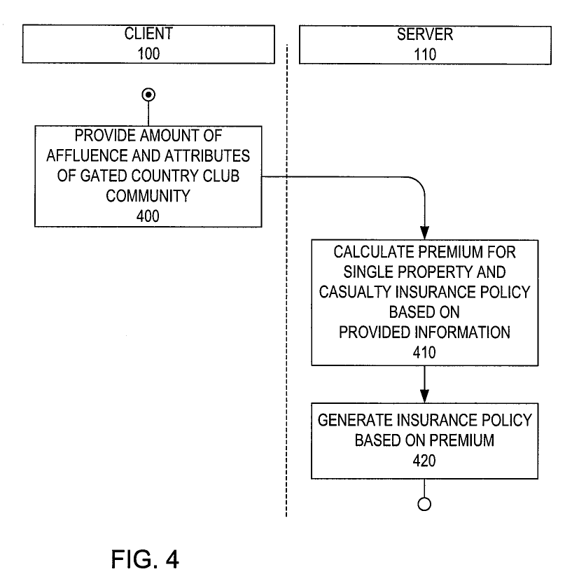

FIG. 4 illustrates an example of a process for generating a single property and casualty insurance policy for a homeowner based on an amount of the homeowner's affluence and attributes associated with a gated country club community in which the homeowner lives. In the illustrated embodiment, the amount of the homeowner's affluence and gated country club community attributes are provided (step 400) to server 110. Server 110 calculates (step 410) a premium for the single insurance policy based on the provided information, and generates (step 420) the insurance policy based on the calculated premium.

In this embodiment, for example, the risk evaluation for underwriting the insurance protection may be based on factors such as: the country club size and its geographic locality, number of members and residences, the financial status of the prospective policyholder (based on provided data or credit report data, for example), period of residence, the location of the property, its construction characteristics and installed safety measures. Other relevant factors may includes coverages, limits, descriptions of the assets, scheduled personal property, loss history, and any prior lapse of coverage of the prospective policyholder. Insured automobile can be evaluated by make, model and year, driver age, driving records and marital status for example. The general wealth of the community may also be a factor.

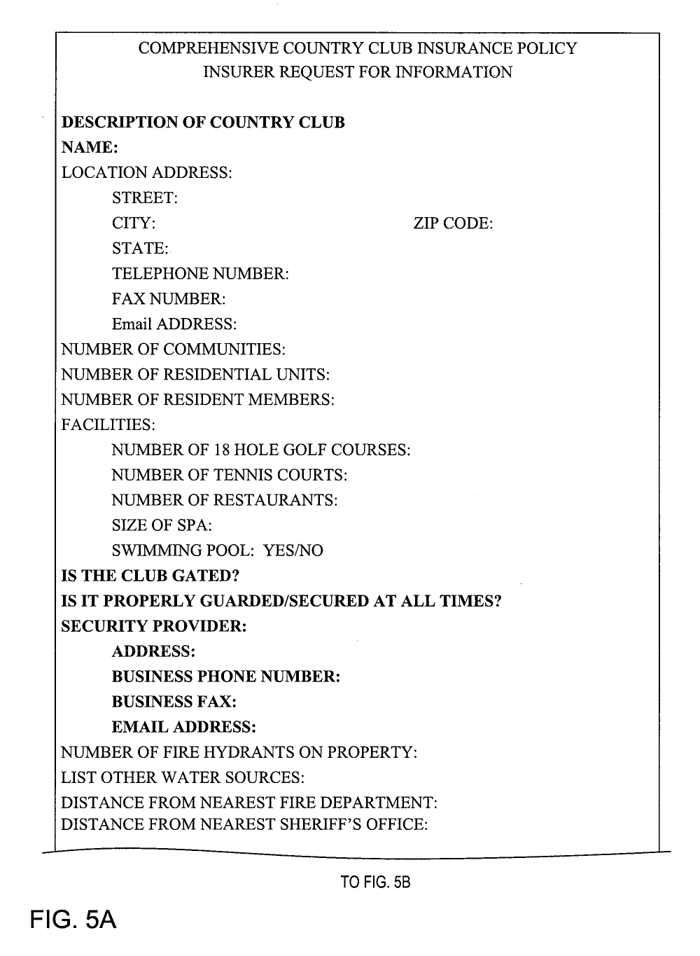

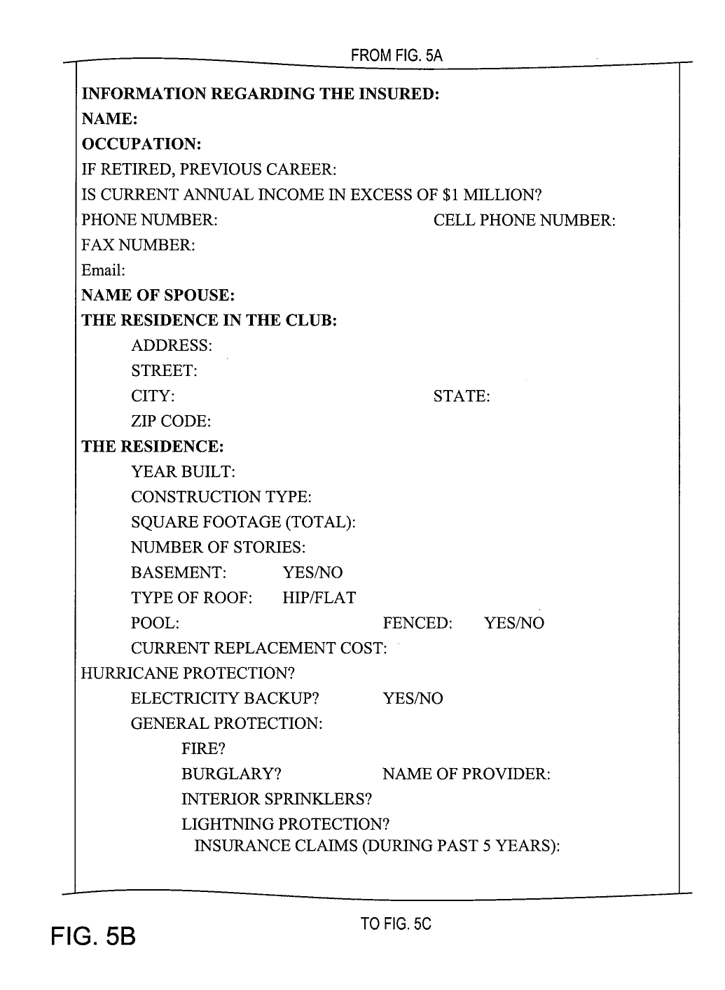

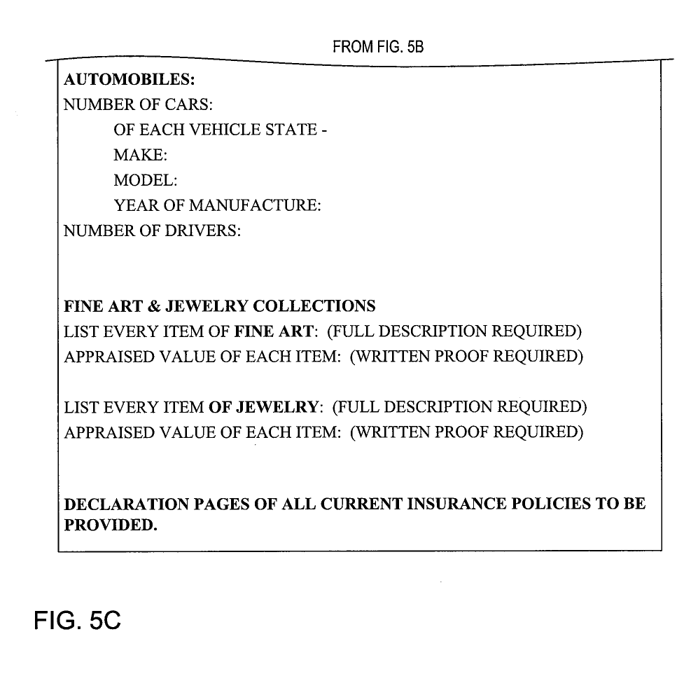

FIGS. 5A, 5B and 5C illustrate an example of an insurance policy request for information form that may be utilized in connection with the embodiments of the present disclosure. This form provides additional examples of the type of information that may be provided to server 110 in connection with the embodiments of the present disclosure.

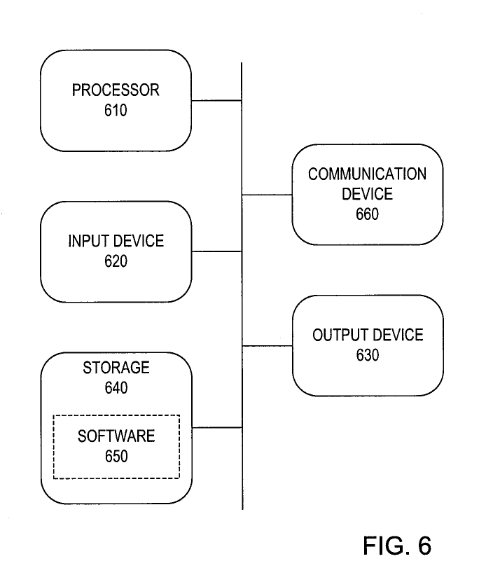

FIG. 6 illustrates an example of a computing device, which may generally correspond to client 100 and server 110. The form of computing device 600 may be widely varied. For example, computing device 600 may be a personal computer, workstation, server, handheld computing device, or any other type of microprocessor-based device. Computing device 600 may include, for example, one or more of processor 610, input device 620, output device 630, storage 640, and communication device 660. These elements may also be widely varied.

For example, input device 620 may include a keyboard, mouse, pen-operated touch screen or monitor, voice-recognition device, or any other device that provides input. Output device 630 may include, for example, a monitor, printer, disk drive, speakers, or any other device that provides output.

Storage 640 may include, for example, volatile and nonvolatile data storage, including one or more electrical, magnetic or optical memories such as a RAM, cache, hard drive, CD-ROM drive, tape drive or removable storage disk. Communication device 660 may include, for example, network interface card, modem or any other device capable of transmitting and receiving signals over a network. The components of the computing device may be connected, for example, via a physical bus or wirelessly.

Software 650, which may be stored in storage 640 and executed by processor 610, may include, for example, the application programming that embodies the functionality of the present disclosure (e.g., as embodied in server 110). Software 650 may include, for example, a combination of servers such as application servers and database servers.

Network 105 may include any type of interconnected communication system, which may implement any communications protocol, which may be secured by any security protocol. The corresponding network links may include, for example, telephone lines, DSL, cable networks, T1 or T3 lines, wireless network connections, or any other arrangement that implements the transmission and reception of network signals.

The computing device may implement any operating system, such as Windows or UNIX for example. Software 650 may be written in any programming language or based on any application framework, such as C, C++, Java, Flash or Flex for example. In various embodiments, application software embodying the functionality of the present disclosure may be deployed on a standalone machine, in a client/server arrangement or through a Web browser as a Web-based application or Web service, for example.

Although the claimed subject matter has been fully described in connection with examples thereof with reference to the accompanying drawings, it is to be noted that various changes and modifications will become apparent to those skilled in the art. Such changes and modifications are to be understood as being included within the scope of the present disclosure as defined by the appended claims.

What is claimed is:

1. A method, comprising:
receiving one or more attributes of a residential community in which a homeowner owns a residence;
determining whether the attributes satisfy criteria to qualify the homeowner for an insurance policy;
calculating, if the criteria is satisfied, a premium for the insurance policy; and
generating the insurance policy based on the calculated premium.

2. The method of claim 1, further comprising:
receiving an indication of affluence of the homeowner; and
determining whether the indication of affluence satisfies the criteria.

3. The method of claim 1, wherein the criteria require the homeowner to be a member of a country club.

4. The method of claim 1, wherein the criteria require the residential community to be secured.

5. The method of claim 1, wherein the criteria require the residential community to be a secured country club community.

6. The method of claim 1, wherein the insurance policy includes property insurance coverage and casualty insurance coverage.

7. The method of claim 3, wherein the property insurance coverage includes coverage for the residence of the homeowner.

8. The method of claim 3, wherein the property insurance coverage includes coverage for one or more assets owned by the homeowner and housed in the residence of the homeowner.

9. The method of claim 5, wherein the assets include an automobile.

10. The method of claim 5, wherein the assets include art.

11. The method of claim 5, wherein the assets include jewelry.

12. A method, comprising:
receiving one or more attributes of a residential community in which a homeowner owns a residence;
calculating a premium for an insurance policy for the homeowner based on the attributes; and
generating the insurance policy based on the calculated premium.

13. The method of claim 12, further comprising:
receiving an indication of affluence of the homeowner; and
calculating the premium based on the indication of affluence.

14. The method of claim 12, wherein the attributes specify that the homeowner is a member of a country club.

15. The method of claim 12, wherein the attributes specify that the residential community is secured.

16. The method of claim 12, wherein the attributes specify that the residential community is a secured country club community.

17. The method of claim 12, wherein the insurance policy includes property insurance coverage and casualty insurance coverage.

18. The method of claim 17, wherein the property insurance coverage includes coverage for the residence of the homeowner.

19. The method of claim 17, wherein the property insurance coverage includes coverage for one or more assets owned by the homeowner and housed in the residence of the homeowner.

20. The method of claim 19, wherein the assets include an automobile.

21. The method of claim 19, wherein the assets include art.

22. The method of claim 19, wherein the assets include jewelry.

23. A computer embodying instructions to:
calculate a premium for a single property and casualty insurance policy for a homeowner based on an amount of affluence and a residence in a secured country club community; and
generate the insurance policy based on the calculated premium.
